(19) United States
(12) Patent Application Publication
(10) Pub. No.: US 2009/0283993 A1
(43) Pub. Date: Nov. 19, 2009

(54) Instrument panel having an airbag therein and method for forming thereof

(76) Inventors: Paul Finch, Northville, MI (US); Sunil Nikam, Canton, MI (US); Raymond E. Kalisz, Livonia, MI (US)

Correspondence Address: BROOKS KUSHMAN P.C./FGTL, 1000 TOWN CENTER, 22ND FLOOR, SOUTHFIELD, MI, 48075-1238, US

(21) Appl. No.: 12/152,298

(22) Filed: May 14, 2008

(51) Int. Cl. B60R 21/16

(52) U.S. Cl. 280/732

(57) ABSTRACT

Several embodiments take the form of an instrument panel having an airbag therein for a motor vehicle. The instrument panel includes a pre-constructed substrate that includes a mounting surface and a reference surface. The instrument panel also includes a cover including a cover skin layer and a woven layer. The cover skin layer has an outer surface that defines a stitched region for presentation to an occupant and an airbag region that is separate from the stitched region. The woven layer has an inner surface that is coupled to the mounting surface of the substrate and coupled to the mounting surface via an adhesive. The stitched region is configured to receive at least one stitch and the airbag region corresponds to at least part of an area where the airbag impacts the cover skin layer during a deployment of the airbag. Other embodiments relate forming an instrument panel.

### BACKGROUND

1. Technical Field

Embodiments of the present invention relate to instrument panels equipped with airbags and to methods for forming such instrument panels.

2. Background Art

Instrument panel covers that have airbags therein and techniques for forming such instrument panel covers are well known in the art.

For example, U.S. Pat. No. 7,100,941 B2 to Riha et al. discloses an apparatus and a method that relate to the use of fabric material in the manufacture of an air bag deployment system. Riha '941 includes an air bag cover for an air bag safety system for a vehicle comprising a fabric outer layer having a frontside and a backside and a substrate containing an opening wherein the opening has a periphery. The substrate is preferably formed by low pressure molding, wherein the fabric outer layer overlies the opening in the substrate, and wherein the fabric outer layer is weakened at a location that is adjacent or overlies the substrate opening periphery.

### SUMMARY

Several embodiments of the present invention take the form of an instrument panel for a motor vehicle. The instrument panel is equipped with an airbag. The instrument panel includes a pre-constructed substrate and a cover. The substrate includes a mounting surface and a reference surface. The cover includes a woven layer and a cover-skin layer. The woven layer includes an inner surface that is coupled to the mounting surface via an adhesive. The cover skin layer includes an outer surface that defines a stitched region and an airbag region. The stitched region is configured to receive at least one stitch for presentation to an occupant. The airbag region, which is separate from the stitched region, corresponds to at least part of an area where the airbag impacts the cover skin layer during a deployment of the airbag.

Several embodiments of the present invention take the form of a method for forming a motor-vehicle instrument panel that is equipped with an airbag, such as the one described in the previous paragraph. The method includes providing a substrate and a cover, such as those previously described; applying an adhesive to at least one of the substrate and the cover; and wrapping the cover over the substrate to couple the cover thereto.

### DRAWINGS

Several embodiments of the present invention may be best understood by referring to the following Detailed Description in conjunction with the accompanying Figures, in which:

FIG. 1 illustrates a cross-sectional view of a portion of an instrument panel cover being pressure molded to a substrate according to the prior art;

FIG. 2 illustrates a perspective view of an instrument panel, which is equipped with an airbag, according to an embodiment of the present invention;

FIG. 3 illustrates a view taken along line 3-3 in FIG. 2;

FIG. 4 illustrates a view taken along line 4-4 of FIG. 2; and

FIG. 5 illustrates a flow diagram depicting a method according to an embodiment of the present invention.

The Figures are not necessarily to scale and may be simplified for clarity.

### DETAILED DESCRIPTION

As used in this section, and unless otherwise indicated, the term “embodiment” refers to “embodiment of the present invention,” the articles “a”, “an”, and “the” comprise plural referents, and all numerical quantities are modified by the word “about”.

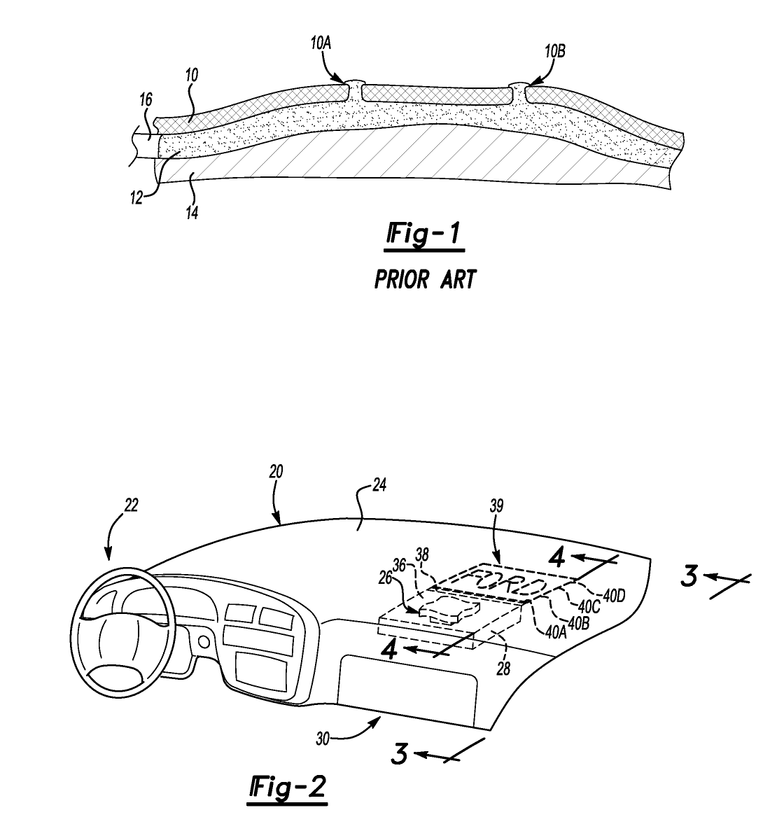

FIG. 1 illustrates a partial cross-sectional view of a motor-vehicle instrument-panel cover 10 being pressure molded to a substrate 12 according to the prior art. FIG. 1 is simplified for clarity. The depicted portion of the cover 10 includes two channels 10a, 10b, which may be configured to receive one or more stitches (not shown). The substrate material 12 may be applied between the cover and a mold base material 14 (or fixture) via a nozzle 16 or other suitable dispensing means. As depicted in FIG. 1, the pressure molding process may cause a “bleed through” of the substrate material 12 through one or more of the channels 10a-10b of the instrument panel cover 10. This “bleed-through” may create an unsightly aesthetic appearance to passengers in the motor vehicle.

FIG. 2 illustrates a perspective view of an instrument panel 20 that is located in a vehicle 22 according to an embodiment of the present invention. Part of the panel 20 forms a cover 24 that hides an airbag system 26 (shown in phantom) when installed. A substrate 27 generally supports the cover 24. The airbag system 26 may be positioned within the substrate 27. The airbag system 26 can be any suitable system having an inflatable airbag 28 for protecting a passenger seated in a passenger space 30. While the passenger space 30 is illustrated as being in the front passenger compartment of the vehicle 22, the passenger space can also be located elsewhere, such as in the driver's side or the rear passenger compartment. The air bag system 26 can alternatively or additionally be a rear and/or side impact air bag system.

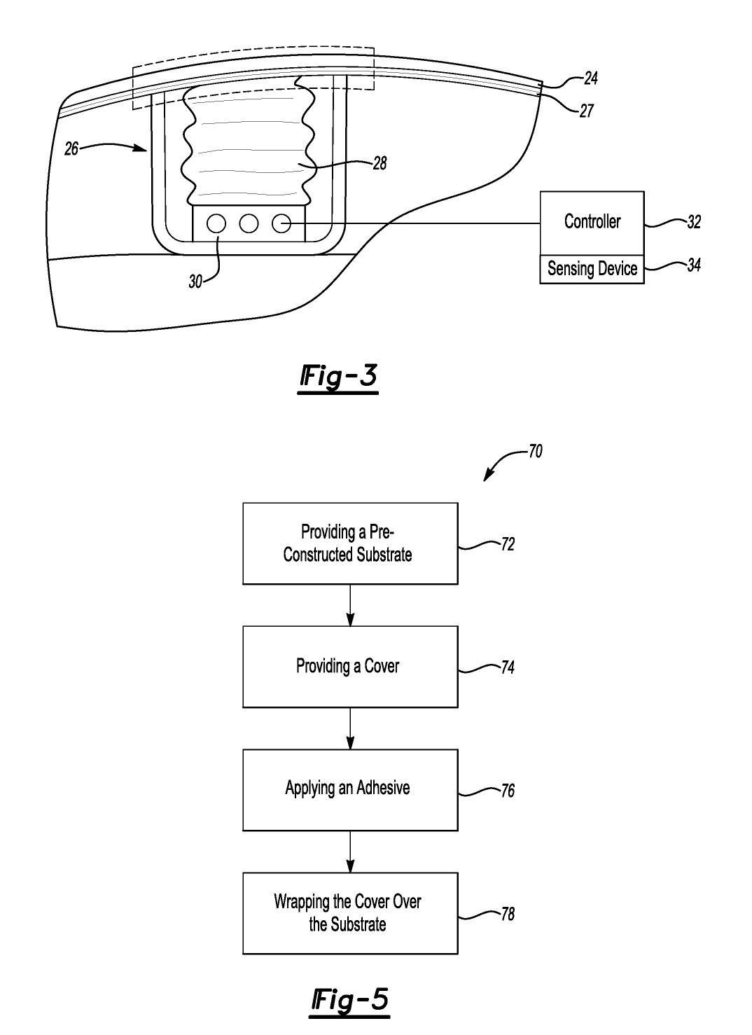

The airbag system 26 can be of a conventional type. Referring to FIG. 3, for example, the airbag system 26 includes an inflator 30 for inflating the airbag 28 in response to a signal from a controller 32. Such a signal may be indicative of a collision from a sensing device 34. Airbag systems are well known in the art. Thus, a skilled artisan will recognize that the airbag system 26 may undertake a variety of different configurations. One or more airbag doors (not shown) may be positioned over the airbag 28 and open towards the outer surface of the cover 24 to release the airbag 28 in the event a collision is detected.

With reference to FIG. 2, the cover 24 defines at least two regions: an airbag region 36 and a stitched region 38. The airbag region 36 generally includes an area positioned over the airbag system 26 and a portion of the area along the cover 24. The airbag region 36 of the cover 24 generally covers the entire airbag system 26 and extends outwardly past the airbag system 26 on the cover 24. The stitched region 38 generally includes an area along the cover 24 and the substrate 27. The stitched region 38 is generally configured to receive one or more stitches. Such a stitched region 8 is generally visible to a vehicle occupant. The entire outer surface of the cover 24 is visible to the user. A stitch pattern 39 is generally formed on the outer surface of the cover 24 and within the stitched region 39. A plurality of stitches may be formed within the stitch pattern 39 for aesthetic purposes. As shown in FIG. 2, in one such example, the stitch pattern may define text such as “FORD.” It is generally contemplated that any such stitch pattern may be formed or employed within the stitch region 38 of the cover 24.

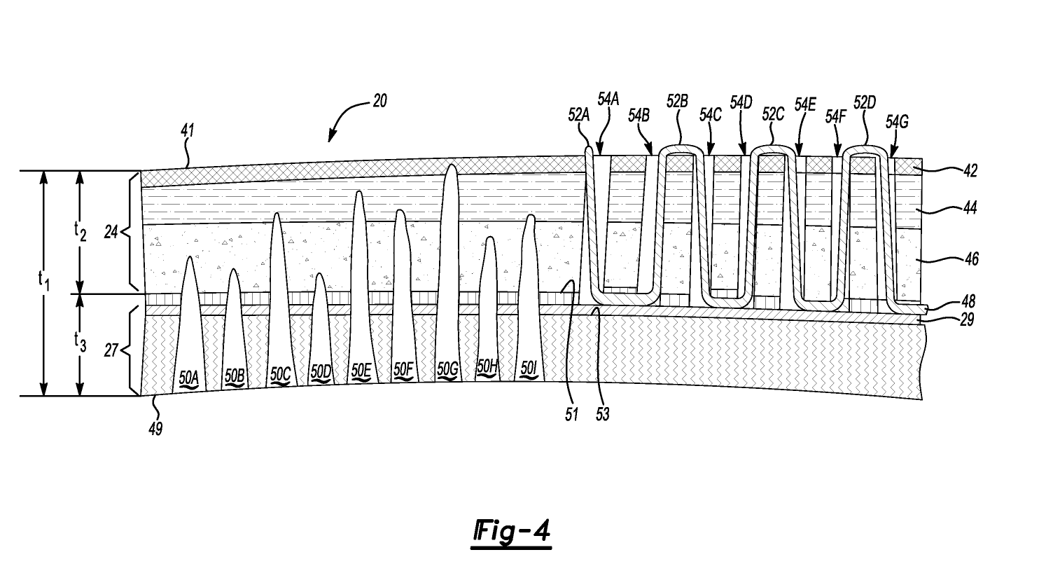

FIG. 4 illustrates a partial, cross-sectional view of the instrument panel 20, in which an adhesive portion 29 couples the cover 24 to the substrate 27, as previously described. The cover 24 includes a cover skin 42 that defines an outer surface 41 of the cover 24. In an embodiment, the cover 24 includes at least one other layer. In the shown embodiment, the cover includes layers 44, 46, and 48.

In an embodiment, the cover 24 has a thickness, labeled t2 in the shown embodiment, in the range of 1.5 mm to 4.0 mm, layer 44 has a thickness in the range of 0.05 mm to 0.1 mm, layer 46 has a thickness in the range of 0.4 mm to 0.6 mm, and layer 48 has a thickness in the range of 1.0 mm to 3.5 mm. The cover 24 may have at least one layer formed of a woven material. In the shown embodiment, the cover skin 42 is formed of a polyurethane material. The layers 44 and 46 are each formed of a polyurethane material, and layer 48 is formed of a woven material. The cover 24 may be leather or leatherette (e.g., simulated leather), such as, for example, a leather or leatherette cover material produced by Benecke-Kaliko AG of Auburn Hills, Mich. However, in other embodiments, a different number of layers and a different combination of materials can be used. In yet another embodiment, a spray polyurethane skin material may be used for a similar application.

As mentioned, the substrate 27 is coupled to the cover 24 via an adhesive 29. In at least one embodiment, the substrate 27 may be formed of a suitable thermoplastic material including, but not limited to, polycarbonate (PC), thermoplastic olefin (TPO), and polypropylene. In certain embodiments, the substrate 27 has a relatively uniform thickness in the range of 3.0 mm-4.0 mm, at least about the airbag region.

The substrate 27 defines a reference surface 49 from which a plurality of spaced-apart holes 50a-50i extends towards the outer surface 31 in the airbag region 36. The holes 50a-50i generally weaken the cover 24 to enable the airbag 28 to pass through the airbag door and the panel 20 upon deployment. In an embodiment, the types of material used to construct the layers 42,44,46,48 as well as the corresponding ranges used for the layers 42,44,46,48 in combination with the number and depth of the holes 50a-50i may be configured to mitigate a ballooning effect during airbag deployment. Generally, the materials of the layers, the corresponding thicknesses of the layers, and the number and depth of the holes 50a-50i of the various layers 42,44, 46, and 48 of the cover 24 may ensure proper deployment of the airbag from the substrate 27 for controlled tearing of the cover 24 to ensure accurate control of airbag inflation. The types of materials used to construct the layers, and the respective thicknesses of the materials and the number and depth of holes 50a-50i may eliminate the need to pre-treat the cover 24 in order to weaken the cover 24 during airbag deployment.

As shown, each hole 50a-50i extends from the reference surface 49, through the substrate 27, and into at least one of the layers 42,44,46,48 of the cover 24. The holes 50a-50i may optionally, but not necessarily, extend into a portion of the cover skin 32. As shown, the holes 50a, 50b, 50d, and 50h extend into layer 46 of the cover 24, the holes 50c, 50e, 50f, and 50i extend into layer 44 of the cover 24, and the hole 50g extends partially into the cover skin 42 of the cover 24. In at least one embodiment, the holes 50a-50i may have a depth of 3.0 mm-7.0 mm.

Still referring to FIG. 4, a suitable stitching material, such as a thread, is interwoven between the outer surface 41 of the cover 24 and the bottom surface 51 of the cover 38b, defining a plurality of stitches 52a-52d in respective pairs of stitch channels 54a-54g. For example, the stitch 52b is defined between the stitch channels 54b and 54c. In an embodiment, the stitches 52a-52d may define an aesthetic pattern for presentation to an occupant. In another embodiment, the stitches 52a-52d at least partially couple the various layers of the cover 24. Of course, a combination of the stitches and an adhesive may also be used to couple the layers to one another.

Referring to FIG. 5, a flowchart 70 illustrates a method, according to an embodiment of the present invention, for forming at least part of an instrument panel, such as the instrument panel 20, having an airbag therein. In block 72, a pre-constructed substrate is provided.

In block 74, the method includes providing a cover, such as the cover 24. For example, the cover 24 may be pre-fabricated, with all the layers coupled to one another. However, block 74 may, in other embodiments, include coupling the various layers to one another, for example, via adhesive. As mentioned, the instrument panel 20 defines a stitched region 38. In an embodiment, at least one of the stitches 52a-52d in the stitched region 38 are ornamental and provide an aesthetic appearance to vehicle occupants. However, in another embodiment, at least one of the stitches 52a-52d may at least partially couple one or more of the layers 42-48 together.

In block 76, the adhesive 29 is applied to one or more of the substrate 27 and the cover 24. The adhesive 29 may be applied to the bottom layer 51 of the cover 24, to the top layer 53 of the substrate 27, or to both the bottom layer 51 of the cover 24 and the top layer 53 of the substrate 27. The adhesive 29 may be of any suitable type and may be dictated by the particular materials used to form the cover 24 and/or the material used to form the substrate 27.

In block 78, the cover 24 is wrapped over the substrate 27 to coupled the cover 24 to the substrate 27. In an embodiment, the cover 24 is hand-wrapped over a pre-molded substrate 27. However, various wrapping methods may be used to couple the cover 24 to the substrate 27, including, but not limited to, a vacuum wrapping process. The vacuum wrapping process may be one where a top of the cover 24 (e.g., the surface visible to a vehicle occupant) is mounted on a mold surface that includes holes positioned over at least a substantial portion of the surface. Once the top of the cover 24 is mounted on the mold surface, a negative pressure is applied, causing a vacuum effect that holds the cover tightly against the mold surface to mitigate any “wrinkling” of the cover 24. A predetermined amount of adhesive may be applied (e.g., sprayed) to the back side of the cover 24 at a proper temperature such that the pre-constructed substrate 27 is positioned about the back side of the cover 24. The cover 24 is then wrapped around the surface of the substrate 27 where the cover 24 is bonded to the substrate 27. A plurality of staples (not shown) are applied to non-visible sections of the cover 24 to further couple the cover 24 to the substrate 27.

The cover 24 and the substrate 27 may not be coupled to one another via a molding process (e.g., pressure molding). In this manner, the cover 24 and the substrate 27 may be fabricated separately and coupled to one another following fabrication. This may allow for various types of stitching on the cover 24 and/or mitigate the substrate mold and/or adhesive from “bleeding through” the stitch channels 54a-54d.

While embodiments of the invention have been illustrated and described, it is not intended that these embodiments illustrate and describe all possible forms of the invention. Rather, the words used in the specification are words of description rather than limitation, and various changes may be made without departing from the spirit and scope of the present invention.

What is claimed:

1. An instrument panel having an airbag therein for a motor vehicle, the instrument panel comprising:
a pre-constructed substrate including a mounting surface and a reference surface; and
a cover including a cover skin layer and a woven layer, the cover skin layer having an outer surface that defines a stitched region for presentation to an occupant and an airbag region that is separate from the stitched region, the woven layer having an inner surface that is coupled to the mounting surface via an adhesive, wherein the stitched region is configured to receive at least one stitch and the airbag region corresponds to at least part of an area where the airbag impacts the cover skin layer during a deployment of the airbag.

2. The instrument panel of claim 1 wherein the cover is hand-wrapped over the substrate.

3. The instrument panel of claim 1 wherein the cover is vacuum formed over the substrate.

4. The instrument panel of claim 1 wherein the cover has a thickness that is between 1.5 mm-4.0 mm.

5. The instrument panel of claim 1 wherein the cover includes a first layer that has a thickness that is between 0.05 mm-0.1 mm.

6. The instrument panel of claim 5 wherein the cover includes a second layer that has a thickness that is between 0.4 mm-0.6 mm.

7. The instrument panel of claim 6 wherein the cover includes a third layer that has a thickness that is between 1.0 mm-3.5 mm.

8. The instrument panel of claim 1 wherein the cover is a leatherette cover.

9. The instrument panel of claim 1 wherein the cover is a leather cover.

10. The instrument panel of claim 1 wherein the cover skin layer is composed of polyvinyl chloride.

11. The instrument panel of claim 1 wherein the cover has a plurality of stitches disposed in the stitched region to define an aesthetic pattern.

12. The instrument panel of claim 11 wherein the stitches at least partially couple the cover skin layer to the woven layer.

13. The instrument panel of claim 1 wherein the cover is independent of stitches in the airbag region.

14. The instrument panel of claim 1 wherein the adhesive solely couples the cover to the substrate.

15. The instrument panel of claim 1 wherein the cover is not pressure molded to the substrate.

16. A method for forming an instrument panel having an airbag therein for a motor vehicle, the method comprising:
providing a pre-constructed substrate comprising a mounting surface and a reference surface;
providing a cover comprising a cover-skin layer and a woven layer, the cover skin layer having an outer surface that defines a stitched region for presentation to an occupant and an airbag region that is separate from the stitched region, the woven layer having an inner surface, wherein the stitched region is configured to receive at least one stitch and the airbag region corresponds to at least part of an area such that the airbag impacts the cover skin layer during a deployment of the airbag;
applying an adhesive to at least one of the inner surface and the mounting surface; and
coupling the cover to the substrate via the adhesive.

17. The method of claim 16 wherein coupling the cover to the substrate further includes hand wrapping the cover over the substrate.

18. The method of claim 16 wherein coupling the cover to the substrate further includes vacuum forming the cover over the substrate.

19. An instrument panel having an airbag therein for a motor vehicle, the instrument panel comprising:
a pre-constructed substrate that includes a mounting surface and a reference surface; and
a cover including a cover skin layer, a first layer that includes a thickness in the range of 0.05 mm-0.1 mm, a second layer that includes a thickness in the range of 0.4 mm-0.6 mm, and a third layer that includes a thickness in the range of 1.0 mm-3.5 mm, the cover skin layer having an outer surface that defines a stitched region including a plurality of stitches for aesthetic presentation to an occupant and an airbag region that is separate from the stitched region, one of the first, second, and third layers defining an inner surface of the cover that is coupled to the mounting surface of the substrate via an adhesive, wherein the stitched region is configured to receive at least one stitch and the airbag region corresponds to at least part of an area where the airbag impacts the cover during a deployment of the airbag, and wherein the cover is independent of stitches in the airbag region.
